(19) United States
(12) Patent Application Publication
(10) Pub. No.: US 2007/0222172 A1
(43) Pub. Date: Sep. 27, 2007

(54) Pedal-operated crank drive assembly for a bicycle

(75) Inventor: Hubert Chen, Taichung Hsien (TW)

Correspondence Address: FOLEY AND LARDNER LLP;SUITE 500, 3000 K STREET NW, WASHINGTON, DC, 20007, US

(73) Assignee: KUN TENG INDUSTRY CO., LTD.

(21) Appl. No.: 11/711,060

(22) Filed: Feb. 27, 2007

(30) Foreign Application Priority Data
Mar. 3, 2006 (TW) 095107213

(51) Int. Cl. B62M 1/02

(52) U.S. Cl. 280/259

(57) ABSTRACT

A pedal-operated crank drive assembly for a bicycle includes a crank axle, a crankset rotatably disposed on the crank axle and including a tubular mount portion which surrounds the crank axle, a crankarm having a drive delivering head which is coupled to the crank axle to be rotated therewith and which has a plurality of angularly displaced recesses, a plurality of pawls disposed respectively in the recesses to be movable between driving and idle positions, and an annular toothed member disposed on the tubular mount portion to couple with the pawls to form a uni-directional mechanism. A plurality of biasing members are disposed to bias a respective one of the pawls to the driving position. A flexible annular shield member is disposed to prevent entry of extraneous dirt into the drive delivering head.

### CROSS-REFERENCE TO RELATED APPLICATION

This application claims priority of Taiwanese patent Application No. 095107213, filed on Mar. 3, 2006.

### BACKGROUND OF THE INVENTION

1. Field of the Invention

This invention relates to a pedal-operated crank drive assembly for a bicycle, more particularly to a pedal-operated crank drive assembly with a ratchet-and-pawl mechanism to drive rotation of a crankset in a uni-direction.

2. Description of the Related Art

A conventional bicycle generally has a ratchet mechanism disposed on a rear wheel hub. However, in order to transmit a pedaling drive to a rear wheel directly, a conventional crank drive assembly 2 is provided, as shown in FIGS. 1 and 2, and is shown to include a crank axle 211 which is mounted to be rotatable relative to a tubular wall 3 of a bicycle bottom bracket shell (not shown), a crankarm 212 which is disposed for receiving a pedaling drive and which has a drive delivering head 213 that is coupled to a coupling end of the crank axle 211 to be rotated therewith, a crankset 22 which has a tubular mount portion 221 that is spaced apart from and that surrounds the drive delivering head 213, and a chainring portion 222 that extends from an outer periphery of the tubular mount portion 221, and a plurality of anti-friction ball bearings 225 which are interposed between the tubular mount portion 221 and the drive delivering head 213 so as to permit rotation of the crankset 22 relative to the drive delivering head 213.

The drive delivering head 213 has four recesses 215 angularly displaced from one another. A ratchet-and-pawl mechanism 23 includes four pawls 231 which are disposed respectively in the recesses 215, an annular toothed portion 223 which is disposed on an inner peripheral edge of the tubular mount portion 221, and a biasing member 232 which is sleeved on the drive delivering head 213 to bias the pawls 231 to engage the annular toothed portion 223 so as to transmit the pedaling drive of the crankarm 212 to the chainring portion 222 in a uni-direction.

Although the direct transmission of the pedaling drive to the bicycle rear wheel (not shown) through the conventional crank drive assembly 2 can shorten the reaction time of the bicycle for purposes of acrobatics or mountain climbing, the drawbacks of the conventional crank drive assembly 2 are as follows:

1. The crank drive assembly 2 cannot work once the biasing member 232 is damaged. Besides, mounting and replacement of the biasing member 232 are inconvenient to conduct.

2. Extraneous dirt and moisture tend to enter the crank drive assembly 2 through a clearance between the tubular mount portion 221 and the drive delivering head 213 to cause damage to the anti-friction ball bearings 225 and the pawls 231.

### SUMMARY OF THE INVENTION

The object of the present invention is to provide a pedal-operated crank drive assembly for a bicycle which has an increased service life and which is resistant to dirt and moisture.

According to this invention, the pedal-operated crank drive assembly includes a crank axle which is adapted to be mounted to be rotatable relative to a tubular wall of a bicycle bottom bracket shell, which includes an intermediate segment that is adapted to be received in the tubular wall, left and right mounting segments that extend from the intermediate segment, and a right coupling segment that extends from the right mounting segment to terminate at a coupling end. A crankset is disposed on and is rotatable relative to the right mounting segment, and includes a chainring carrier which has proximate and distal major wall surfaces, and a tubular mount portion which is opposite to the chainring carrier and which is disposed to surround the right mounting segment. A right crankarm includes a drive applying end for receiving a pedaling drive, and a drive delivering head which is opposite to the drive applying end to deliver the pedaling drive, and which is coupled to the right coupling segment so as to be rotated with the crank axle. The drive delivering head has a forward major wall surface which confronts the distal major wall surface, and which has an accommodating opening extending away from the distal major wall surface and along the rotating axis to form an inner surrounding wall surface that is spaced apart from the tubular mount portion to define an annular accommodation space, and that has a plurality of recesses angularly displaced from one another. A plurality of pawls are disposed respectively in the recesses, and are movable between a driving position, where the pawls extend radially and respectively into the annular accommodation space, and an idle position, where the pawls are retracted radially into the recesses. An annular toothed member is disposed on the tubular mount portion, and extends into the annular accommodation space to couple with the pawls to form a uni-directional mechanism that enables transmission of the pedaling drive when the annular toothed member engages the pawls in the driving position to thereby rotate the chainring carrier, and that disenables the transmission of the pedaling drive when the annular toothed member passes over the pawls by forcing the pawls to the idle position to thereby permit the chainring carrier to remain unmoved in a counterclockwise direction. A plurality of biasing members are respectively received in said recesses to bias the pawls to the driving position. A flexible annular shield member is fitted in the accommodating opening.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a partly sectional view of a conventional crank drive assembly for a bicycle;

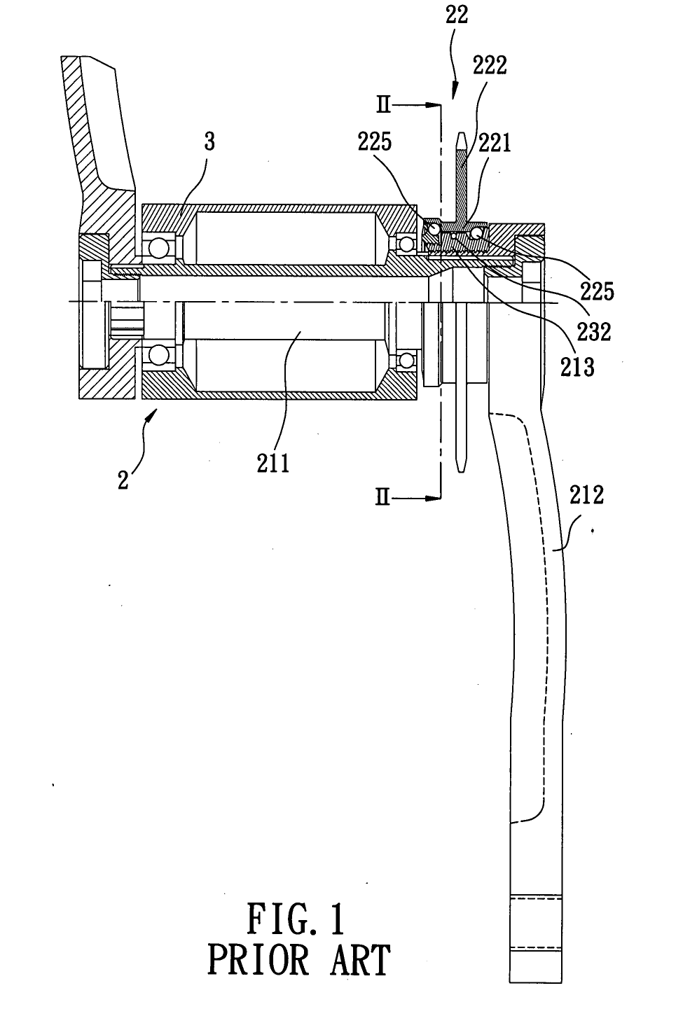

FIG. 2 is a cross-sectional view of the conventional crank drive assembly shown in FIG. 1, taken along lines II-II thereof;

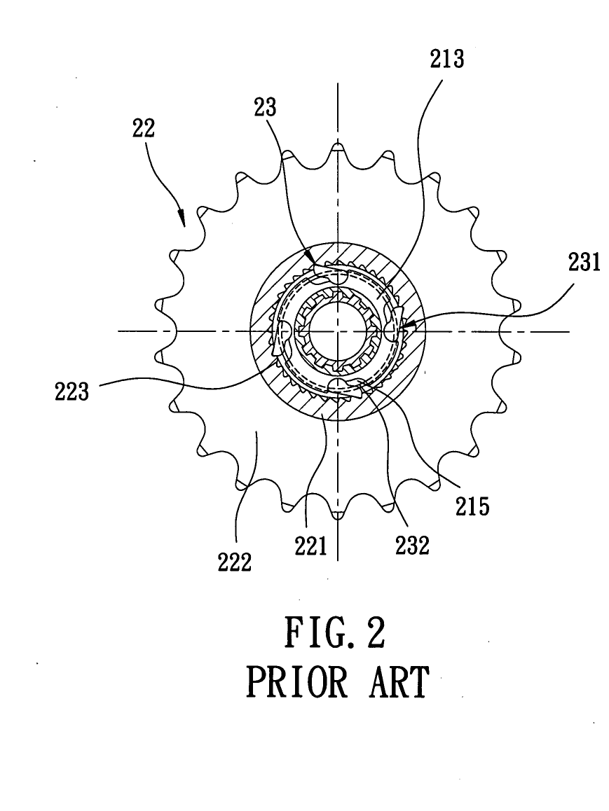

FIG. 3 is a sectional view of the preferred embodiment of a pedal-operated crank drive assembly for a bicycle according to this invention;

FIG. 4 is a fragmentary enlarged sectional view of a portion of the preferred embodiment;

FIG. 5 is a schematic side view of the preferred embodiment; and

FIG. 6 is a cross-sectional view of the preferred embodiment shown in FIG. 3, taken along lines VI-VI thereof.

### DETAILED DESCRIPTION OF THE PREFERRED EMBODIMENT

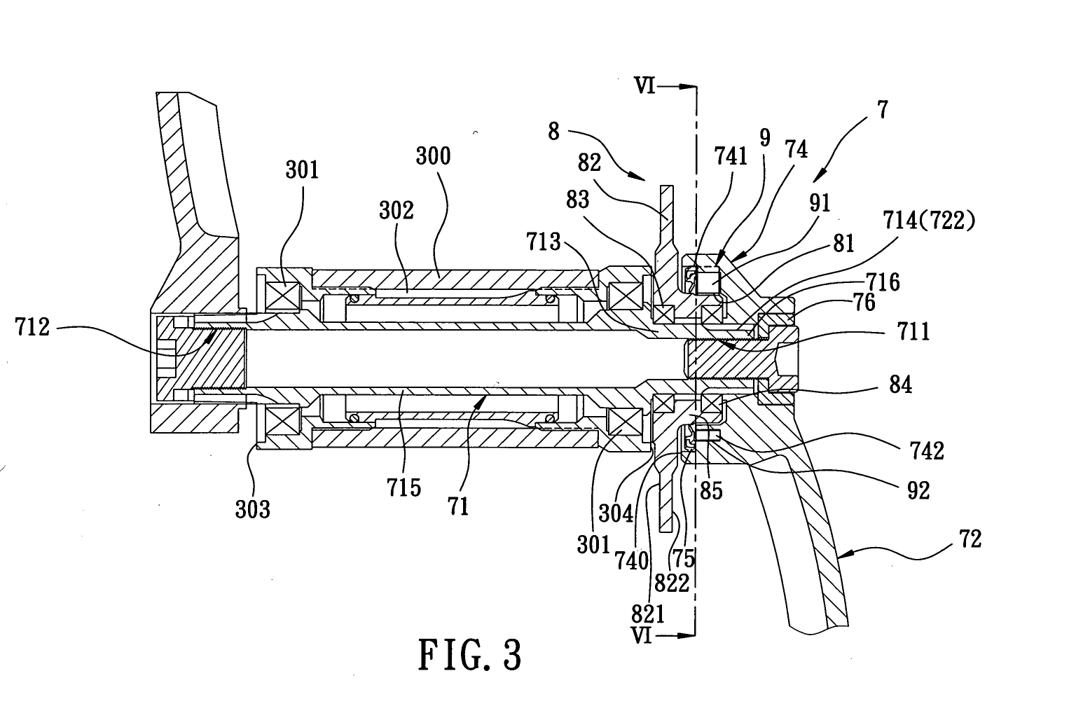

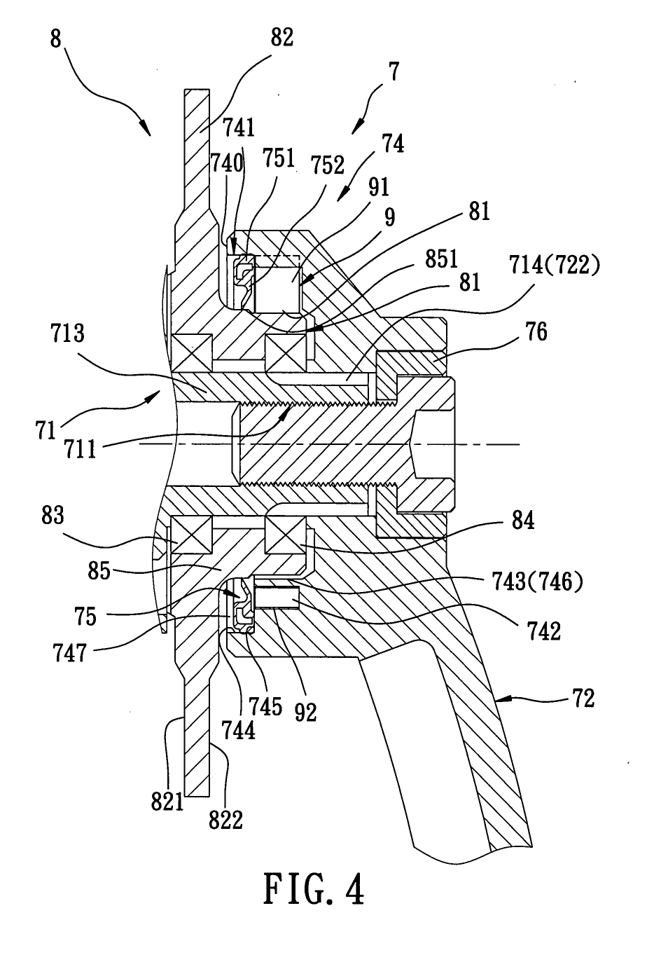

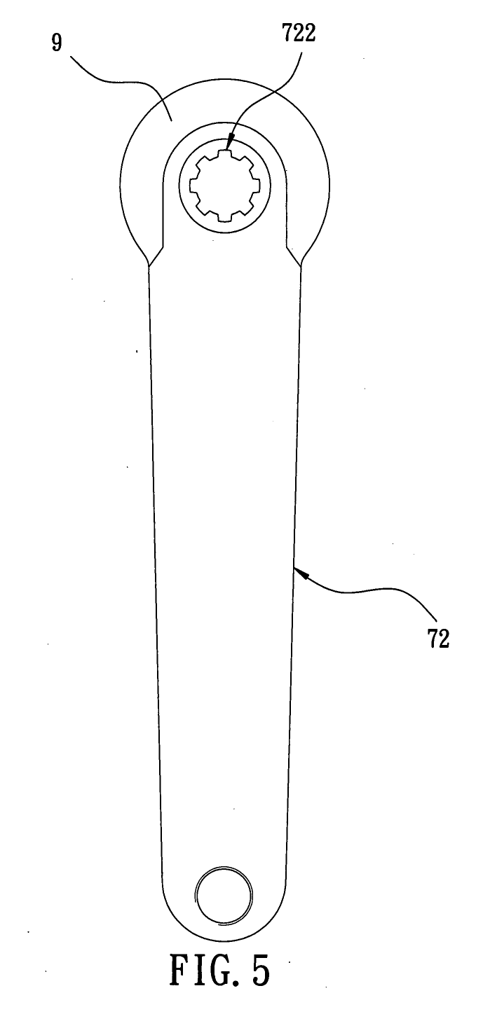

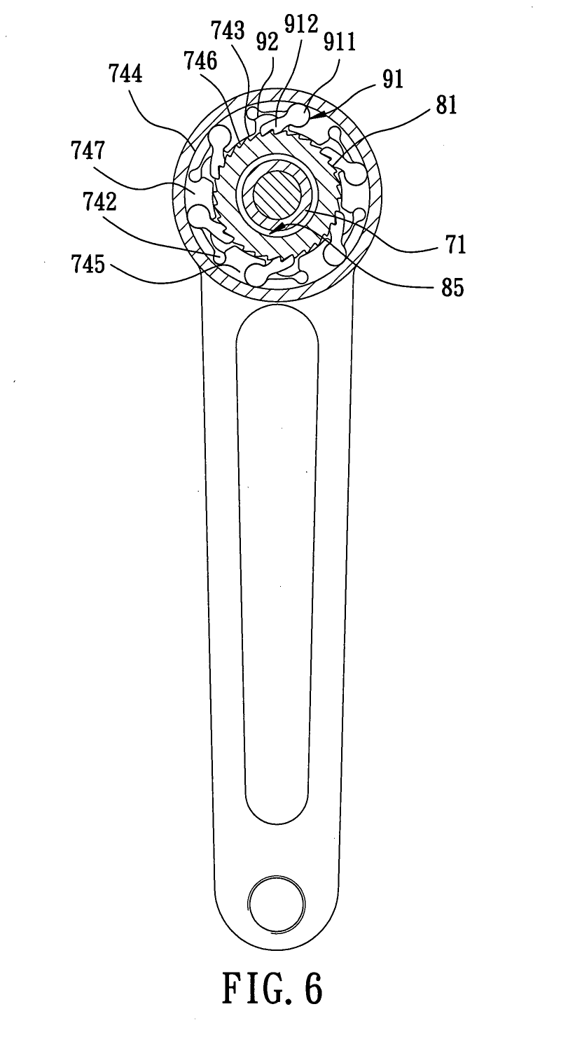

Referring to FIGS. 3 to 6, the preferred embodiment of a pedal-operated crank drive assembly according to the present invention is adapted to be mounted on a bottom bracket shell (not shown) of a bicycle. The bottom bracket shell has a tubular wall 300 which confines an accommodation chamber 302 extending along a rotating axis, and which extends along the rotating axis to terminate at left and right peripheral walls 303,304. The pedal-operated crank drive assembly of this embodiment is shown to comprise a crank axle 71, a crankset 8, a right crankarm 7, a ratchet-and-pawl mechanism 9, and a flexible annular shield member 75.

The crank axle 71 is adapted to be mounted to be rotatable relative to the tubular wall 300 about the rotating axis, and includes an intermediate segment 715 which is adapted to be received in the accommodation chamber 302 of the tubular wall 300 to be rotatably held by central anti-friction bearings 301, left and right mounting segments 712,713 which extend from the intermediate segment 715 and beyond the left and right peripheral walls 303,304 of the tubular wall 300, respectively, and a right coupling segment 711 which extends from the right mounting segment 713 to terminate at a coupling end 716.

The crankset 8 is disposed to surround and to be rotatable relative to the right mounting segment 713 about the rotating axis, and includes a chainring carrier 82 and a tubular mount portion 85 opposite to each other along the rotating axis. Two annular anti-friction bearings 83,84 are interposed between the chainring carrier 82 and the right mounting segment 713, and between the tubular mount portion 85 and the right mounting segment 713, respectively, so as to permit rotation of the crankset 8 relative to the right mounting segment 713. The chainring carrier 82 has a proximate major wall surface 821 which is adapted to confront the right peripheral wall 304, and a distal major wall surface 822 which is opposite to the proximate major wall surface 821 along the rotating axis.

The right crankarm 7 includes a drive applying end 72 for receiving a pedaling drive applied by a user, and a drive delivering head 74 which is integrally formed with and which is opposite to the drive applying end 72 to deliver the pedaling drive. The drive delivering head 74 is coupled to the right coupling segment 711 by means of a limiting member 76 so as to be rotated with the crank axle 71 about the rotating axis. Moreover, the right coupling segment 711 has an external toothed portion 714 which extends parallel to the rotating axis. The drive delivering head 74 has an internal toothed portion 722 which threadedly engages the external toothed portion 714 so as to couple the drive delivering head 74 to the crank axle 71.

The drive delivering head 74 has a forward major wall surface 740 which confronts the distal major wall surface 822 of the chainring carrier 82. The forward major wall surface 740 has an accommodating opening 747 which extends away from the distal major wall surface 822 and along the rotating axis to form an inner surrounding wall surface 741 that is spaced apart from the tubular mount portion 85 to define an annular accommodation space 746, and that has a plurality of recesses 742 angularly displaced from one another about the rotating axis. In particular, the inner surrounding wall surface 741 includes smaller-diameter and larger-diameter inner surface segments 744,743 which are disposed proximate to and distal from the forward major wall surface 740, respectively, and which define the accommodating opening 747 and the annular accommodation space 746, respectively, and an annular shoulder surface segment 745 which is formed between the smaller-diameter and larger-diameter inner surface segments 744,743.

The ratchet-and-pawl mechanism 9 includes a plurality of pawls 91, an annular toothed member 81, and a plurality of biasing members 92.

Each of the pawls 91 has a pivoted end 911 which is pivotably disposed in a respective one of the recesses 742, and a coupling end 912 which is movable by means of pivotal movement of the pivoted end 911 between a driving position, where the coupling end 912 extends radially into the annular accommodation space 746, and an idle position, where the coupling end 912 is retracted radially into the respective recess 742.

The annular toothed member 81 is integrally formed with and is disposed on the tubular mount portion 85, and extends into the annular accommodation space 746 to engage the pawls 91 so as to form a uni-directional mechanism that enables transmission of the pedaling drive of the right crankarm 7 when the annular toothed member 81 engages the pawls 91 in the driving position to thereby drive the chainring carrier 82 to rotate in a clockwise direction, and that disenables the transmission of the pedaling drive when the annular toothed member 81 passes over the pawls 91 by forcing the pawls 91 to the idle position to thereby permit the chainring carrier 82 to remain unmoved in a counterclockwise direction. In other words, when the user stops pedaling in the course of forward movement of the bicycle, the chainring carrier 82 and the annular toothed member 81 will still rotate in the clockwise direction due to inertia. At this time, the right crank arm 7 is not rotated, so that the pawls 91 are forced to the idle position. Since the chainring carrier 82 continues to rotate, a chain (not shown) trained on a chainring (not shown) that is locked on the chainring carrier 82 can be shifted for speed change.

Each of the biasing members 92 is received in a respective one of the recesses 742 to bias the corresponding pawl 91 to the driving position.

The shield member 75 is fitted in the accommodating opening 747, and has an outer peripheral edge portion 751 which is configured to abut against the larger-diameter inner surface segment 744 and the annular shoulder surface segment 745, and an inner peripheral edge portion 752 which is opposite to the outer peripheral edge portion 751 in radial directions, and which is kept dragging on an annular abutment 851 of the tubular mount portion 85 when the drive delivering head 74 is rotated about the rotating axis so as to prevent entry of extraneous dirt and moisture into the annular accommodation space 746.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A pedal-operated crank drive assembly for a bicycle including a bottom bracket shell which has a tubular wall that confines an accommodation chamber extending along a rotating axis, and that extends along the rotating axis to terminate at left and right peripheral walls, said pedal-operated crank drive assembly comprising:
a crank axle which is adapted to be mounted to be rotatable relative to the tubular wall about the rotating axis, which includes an intermediate segment that is adapted to be received in the accommodation chamber of the tubular wall, left and right mounting segments that extend from said intermediate segment and beyond the left and right peripheral walls, respectively, and a right coupling segment that extends from said right mounting segment to terminate at a coupling end;
a crankset disposed on and rotatable relative to said right mounting segment about the rotating axis, and including
a chainring carrier which has a proximate major wall surface that is adapted to confront the right peripheral wall, and a distal major wall surface that is opposite to said proximate major wall surface along the rotating axis, and
a tubular mount portion which is opposite to said chainring carrier along the rotating axis, and which is disposed to surround said right mounting segment;
a right crankarm including
a drive applying end for receiving a pedaling drive, and
a drive delivering head which is opposite to said drive applying end to deliver the pedaling drive, and which is coupled to said right coupling segment so as to be rotated with said crank axle about the rotating axis, said drive delivering head having a forward major wall surface which confronts said distal major wall surface, and which has an accommodating opening extending away from said distal major wall surface and along the rotating axis to form an inner surrounding wall surface that is spaced apart from said tubular mount portion to define an annular accommodation space, and that has a plurality of recesses which are angularly displaced from one another about the rotating axis;
a plurality of pawls disposed respectively in said recesses, and movable between a driving position, where said pawls extend radially into said annular accommodation space, and an idle position, where said pawls are retracted radially and respectively into said recesses;
an annular toothed member which is disposed on said tubular mount portion, and which extends into said annular accommodation space to engage said pawls so as to form a uni-directional mechanism that enables transmission of the pedaling drive when said annular toothed member engages said pawls in the driving position to thereby drive said chainring carrier to rotate in a clockwise direction, and that disenables the transmission of the pedaling drive when said annular toothed member passes over said pawls and forces said pawls to the idle position to thereby permit said chainring carrier to remain unmoved in a counterclockwise direction;
a plurality of biasing members which are respectively received in said recesses, and each of which is disposed to bias a respective one of said pawls to the driving position; and
a flexible annular shield member which is fitted in said accommodating opening.

2. The pedal-operated crank drive assembly of claim 1, wherein said drive delivering head is integrally formed with said drive applying end.

3. The pedal-operated crank drive assembly of claim 1, further comprising two annular anti-friction bearings which are interposed between said chainring carrier and said right mounting segment, and between said tubular mount portion and said right mounting segment, respectively, so as to permit rotation of said crankset relative to said right mounting segment.

4. The pedal-operated crank drive assembly of claim 1, wherein said flexible annular shield member has an outer peripheral edge portion that is disposed to be engaged with said inner surrounding wall surface, and an inner peripheral edge portion that is opposite to said outer peripheral edge portion in radial directions, and that is kept dragging on said tubular mount portion when said drive delivering head is rotated about the rotating axis so as to prevent entry of extraneous dirt into said annular accommodation space.

5. The pedal-operated crank drive assembly of claim 4, wherein said inner surrounding wall surface includes smaller-diameter and larger-diameter inner surface segments which are disposed proximate to and distal from said forward major wall surface, respectively, and which define said accommodating opening and said annular accommodation space, respectively, and an annular shoulder surface segment which is formed between said smaller-diameter and larger-diameter inner surface segments, said outer peripheral edge portion of said flexible annular shield member being configured to abut against said larger-diameter inner surface segment and said annular shoulder surface segment.

6. The pedal-operated crank drive assembly of claim 1, wherein said right coupling segment has an external toothed portion which extends parallel to the rotating axis, said drive delivering head having an internal toothed portion which threadedly engages said external toothed portion so as to couple said drive delivering head to said crank axle.
